(19) United States
(12) Patent Application Publication
(10) Pub. No.: US 2014/0261375 A1
(43) Pub. Date: Sep. 18, 2014

(54) APPARATUS FOR EFFICIENT PACKAGING OF CHARCOAL BRIQUETTES

(71) Applicants: Randolph Pafford, Homestead, FL (US); Dave Shrader, Commerce Township, MI (US)

(72) Inventors: Randolph Pafford, Homestead, FL (US); Dave Shrader, Commerce Township, MI (US)

(21) Appl. No.: 13/826,586

(22) Filed: Mar. 14, 2013

(51) Int. Cl. A47J 37/07

(52) U.S. Cl. CPC A47J 37/079
USPC 126/25 B

(57) ABSTRACT

A handheld, packaged charcoal briquette assembly or apparatus for igniting within a charcoal grill is disclosed. The apparatus includes a shell having a base, a pair of trapezoidal sidewalls extending upward from a first pair of parallel perimeter edges of the base, and a pair of triangular sidewalls extending upward from a second pair of parallel perimeter edges the base. The sidewalls converge away from the base and toward a top surface or edge. The base, sidewalls, and top surface or edge combine to define an enclosed compartment. Charcoal briquettes are housed within the enclosed compartment. Igniting any outer surface of the assembly slowly burns the shell, and heat is transferred from the shell to the charcoal briquettes.

### TECHNICAL FIELD

The present disclosure generally relates to a packaging of charcoal briquettes, and more specifically to a flammable packaged assembly of charcoal briquettes for use in a charcoal grill.

### BACKGROUND

Charcoal grills are well known in the art. For example, the ONE-TOUCH® charcoal grill sold by WEBER® includes a porcelain-enameled bowl for receiving charcoal, a steel cooking grate for holding food at a distance above the charcoal, and a lid for covering the food and containing heat within the grill.

To begin preparing the grill for cooking food, one must typically pour charcoal briquettes from a bag into the bowl of the grill. This can be a difficult task, as more charcoal briquettes than desired can fall from the bag into the bowl. Thereafter, the charcoal briquettes can be grouped and arranged by hand. It is typically desirable to pile the charcoal briquettes into a mound for heat distribution between and heat containment within the charcoal briquettes.

### SUMMARY

According to one embodiment, a packaged charcoal briquette apparatus is provided. The apparatus includes a rectangular base having a first pair of parallel perimeter edges and a second pair of perimeter edges. A first pair of sidewalls of the apparatus each extend upward from one of the first pair of parallel perimeter edges. A second pair of sidewalls each extend upward from one of the second pair of parallel perimeter edges. The second pair of sidewalls converge upward toward one another. The rectangular base surface and the sidewalls define an enclosed container. A plurality of charcoal briquettes are stacked within the enclosed container.

According to another embodiment, a flammable packaged charcoal apparatus includes a base surface. At least three sidewalls extend upward from the base surface and converge at a height laterally spaced from the base surface. The base surface and the sidewalls define an enclosed container. A plurality of charcoal briquettes are stacked within the enclosed container.

According to another embodiment, a flammable packaged charcoal apparatus includes a base surface. At least three polygonal sidewalls converge at a height laterally spaced from the base surface. The sidewalls are coated, saturated, or impregnated with a flame perpetuating substance. A plurality of charcoal briquettes are stacked in a tiered formation within an enclosed container that is defined by the sidewalls and the base surface.

According to at least one embodiment, the first pair of sidewalls are triangular and the second pair of sidewalls are trapezoidal. The trapezoidal sidewalls converge and meet to define a top edge, and a handle extends from the top edge.

### BRIEF DESCRIPTION OF THE DRAWINGS

FIG. 1 is a perspective view of a flammable charcoal briquette package; and

FIG. 2 is a perspective cross-sectional view of a packaged charcoal briquette apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It should be understood that any references in the present disclosure to “upper,” “lower,” “top,” “bottom,” “side,” and “upward” are meant as not to be limiting, but rather exemplary relative to other parts of the assembly. For example, a base with sidewalls extending upwardly to a top surface is not meant to be limited to such an arrangement, and can be understood to encompass embodiments in which the assembly is inverted such that the sidewalls extend downwardly to a surface below the base.

Referring to FIGS. 1 and 2, a packaged charcoal briquette assembly or apparatus 10 is illustrated. The apparatus 10 is a flammable, handheld container of charcoal that is suitable for an outdoor charcoal grill. The apparatus 10 is sized such that it can be placed into a bowl of a charcoal grill unit. After placing into the grill, the apparatus 10 is designed such that it may be ignited to burn quickly and cleanly so that the grill is readily available to cook food. When using the apparatus 10, users do not have to directly handle charcoal briquettes, keeping their hands and clothing clean. Details of the charcoal briquette apparatus 10 are described below according to embodiments of the present invention.

The apparatus 10 includes a shell 12 that defines a cavity therein. The shell 12 may be made of cardboard, paper, or other suitable material that not only has the structural rigidity to support charcoal stored within, but also can be ignited by a match or lighter. According to one embodiment, the shell is layered, presoaked or imbibed with a flammable agent, such as lighter fluid (butane, kerosene, etc.).

The shell 12 includes a generally rectangular base 14. The base 14 acts as the supporting layer for supporting charcoal briquettes above. A plurality of sidewalls extend upward from the base 14. The sidewalls may be of any polygonal shape. In the embodiment illustrated in the Figures, a pair of trapezoidal sidewalls 16 extend from a first pair of parallel perimeter edges 18 of the base 14. Similarly, a pair of triangular sidewalls 20 extend from a second pair of parallel perimeter edges 22 of the base 14. The trapezoidal sidewalls 16 converge upwardly such that upper edges of the sidewalls 16 meet to form an upper surface or top edge 24. The triangular sidewalls 20 may also converge upwardly and end at spaced apart locations along the top edge 24. An enclosed container is therefore defined by the base 14 and sidewalls 16, 20.

Other configurations of the shell 12 are also contemplated. For example, the base 14 may have more or less than four surfaces. Similarly, the shell 12 may have more or less than four sidewalls 16, 20. Furthermore, instead of forming a top edge 24, sidewalls of the shell 12 may end at an upper planar surface or at a point.

A handle 26 may attach to or extend from the top edge 24 of the shell 12. The handle 26 facilities the hand-held transportation of the apparatus 10. The handle 26 may also be made of cardboard such that it may cleanly burn along with the remainder of the shell 12.

The shell 12, including the base 14, the sidewalls 16, 20, and the handle 26 may all be formed from a singular cardboard blank. The blank may have partitioned sections separated by cut lines that can be folded to form all of the surfaces of the shell 12 and handle 26.

Also, the shell may be saturated, coated or impregnated with a flame perpetuating substance. In one illustrative example, this substance includes wax, to encourage burn long enough for heat transfer to the briquettes to light the briquettes. In other instances, other suitable substances may be used.

As shown in FIG. 2, a plurality of charcoal briquettes 28 are contained within the shell 12. Unlike loose charcoal, which is often difficult to stack so that each piece can be lit, the contained charcoal briquettes 28 are stacked in a tiered formation according to the shape of the shell 12. This keeps the charcoal briquettes 28 close together so that a flame burning the shell 12 will burn each of the outer-most charcoal briquettes 28 and optimize the heat transfer between the inner-most and outer-most charcoal briquettes 28. Each of the charcoal briquettes 28 may be presoaked or imbibed with a layer 30 of a flammable agent (e.g., lighter fluid) to facilitate the heat transfer into and between the charcoal briquettes 28.

In use, a user can prepare a charcoal grill (not shown) by simply placing the apparatus 10 into a bowl of the grill. One surface or edge of the shell 12 can be lit by a flame. A slow burn travels around the outside of the shell 12, heating the apparatus 10 and igniting the presoaked layer 30 of the charcoal briquettes 28. After a sufficient time for the charcoal briquettes 28 to increase in temperature, the grill is ready to cook food. Embodiments of the present invention therefore provide quick and easy way to prepare a charcoal grill without the difficulties associated with pouring a proper amount of charcoal briquettes into a grill, arranging the briquettes in a pile, and directly igniting the briquettes themselves.

Furthermore, the apparatus may be sized such that it contains a predetermined number of standard charcoal briquettes 28. This ensures a proper, controlled amount of charcoal briquettes 28 are utilized in the grill. For example, the base 14 may be sized such that the first pair of parallel perimeter edges 18 and the second pair of parallel perimeter edges 22 are each between 5 inches and 10 inches in length. A distance between the base 14 and the top edge 24 may be between 4 and 12 inches. The sizes of the respective surfaces of the shell 12 can be increased or decreased to consequently allow for more or less internal volume within the shell 12, and therefore more or less charcoal briquettes 28 within the shell 12.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A packaged charcoal briquette apparatus, comprising:
a rectangular base having a first pair of parallel perimeter edges and a second pair of parallel perimeter edges;
a first pair of sidewalls, each extending upward from one of the first pair of parallel perimeter edges;
a second pair of sidewalls, each extending upward from one of the second pair of parallel perimeter edges, the second pair of sidewalls converging upward toward one another, wherein the base and the sidewalls define an enclosed container; and
a plurality of charcoal briquettes stacked within the enclosed container.

2. The apparatus of claim 1, wherein the base and sidewalls comprise cardboard.

3. The apparatus of claim 1, wherein the charcoal briquettes are stacked in a generally pyramid shaped configuration.

4. The apparatus of claim 1, wherein the second pair of sidewalls join at a top edge vertically spaced from the rectangular base.

5. The apparatus of claim 4, further including a handle extending from the top edge.

6. The apparatus of claim 4, wherein the first pair of parallel perimeter edges have a length in a range between 5 inches and 10 inches, the second pair of parallel perimeter edges have a length in a range between 5 inches and 10 inches, and a distance between the base and the top edge is in a range between 4 and 12 inches.

7. A cardboard blank for forming at least part of the packaged charcoal briquette apparatus of claim 1, wherein the blank is generally planar and includes the rectangular base, the sidewalls and the handle formed thereon.

8. The apparatus of claim 1, wherein the first pair of sidewalls is triangular in shape.

9. The apparatus of claim 1, wherein the second pair of sidewalls is trapezoidal in shape.

10. The apparatus of claim 1, wherein the enclosed container is coated, saturated or impregnated with a flame perpetuating substance.

11. The apparatus of claim 10, wherein the flame perpetuating substance is wax.

12. A flammable packaged charcoal apparatus, comprising:
a base surface;
at least three sidewalls extending upward from the base and converging at a height laterally spaced from the base surface, wherein the base surface and the sidewalls define an enclosed container; and
a plurality of charcoal briquettes stacked within the enclosed container.

13. The apparatus of claim 12, wherein the sidewalls converge to a top surface.

14. The apparatus of claim 12, wherein two of the at least three sidewalls meet at a top edge.

15. The apparatus of claim 14, further comprising a handle extending from the top edge.

16. The apparatus of claim 12, wherein the charcoal briquettes are stacked in a generally pyramid shaped configuration.

17. The apparatus of claim 12, wherein the charcoal briquettes are covered with a layer of flammable substance.

18. The apparatus of claim 12, wherein the sidewalls are flammable.

19. A flammable packaged charcoal apparatus, comprising:
a base surface;
at least three polygonal sidewalls converging at a height laterally spaced from the base surface, wherein the sidewalls are coated, saturated or impregnated with a flame perpetuating substance; and
a plurality of charcoal briquettes stacked in a tiered formation within an enclosed container defined by the sidewalls and the base surface.

20. The apparatus of claim 19, wherein the sidewalls converge at a point.
